(19) United States
(12) Patent Application Publication
(10) Pub. No.: US 2017/0091307 A1
(43) Pub. Date: Mar. 30, 2017

(54) COMPUTER READABLE RECORDING MEDIUM, EVALUATION METHOD, AND EVALUATION APPARATUS

(71) Applicant: FUJITSU LIMITED, Kawasaki-shi (JP)

(72) Inventors: Yoshiharu Kato, Suginami (JP); Masafumi Yano, Kawasaki (JP)

(21) Appl. No.: 15/267,647

(22) Filed: Sep. 16, 2016

(30) Foreign Application Priority Data
Sep. 30, 2015 (JP) 2015-195265

(51) Int. Cl. G06F 17/30

(52) U.S. Cl. CPC G06F 17/30598; G06F 17/30961; G06F 17/3053

(57) ABSTRACT

A creativity aiding server selects nodes from among a plurality of nodes included in a tree diagram that is generated according to nodes each representing an opinion created by each user to derive a solution to a problem dealt with in a discussion and links each representing relevance between the nodes, by tracking links backward from a solution node representing the solution to an assignment node representing an assignment, the selected nodes being included between the solution node and the assignment node. The creativity aiding server calculates a degree of contribution made by each of the selected nodes in deriving the solution, by using types of the selected nodes and types of the links. The creativity aiding server identifies one or more of the nodes of which the degree of contribution is equal to or higher than a threshold value.

### CROSS-REFERENCE TO RELATED APPLICATION

This application is based upon and claims the benefit of priority of the prior Japanese Patent Application No. 2015-195265, filed on Sep. 30, 2015, the entire contents of which are incorporated herein by reference.

### FIELD

The embodiments discussed herein are related to an evaluation computer program, an evaluation method, and an evaluation apparatus.

### BACKGROUND

In today's ever-changing society, creativity aiding systems (i.e., creativity support systems) to aid people in exploring human creativity and ideas are being used to meet the need of developing products and services that contribute to the society by creating new values. For example, a known creativity aiding system implements the KJ method by which, from among accumulated pieces of information, relevant pieces of information are connected to one another. In recent years, as a technique for aiding the use of the KJ method, a method is known by which a plurality of participants input opinions thereof to a system, so as to generate islands representing the number of groups generated on the basis of the input opinions and so that the opinions are automatically documented on the basis of linking relationships between the islands.
Non-Patent Document 1: “Hassou Shien Guruupuwea Gungen no Kouka—Suuhyaku no Shikenkekka yori Etamono”, Retrieved Sep. 18, 2015, from https://www.jstage.jst.go.jp/article/tjsai/19/2/19_2_105/_article/-char/ja/

When the technique described above is used, however, users' motivations are not enhanced, and it is difficult to make discussions lively. For example, even when the opinions are automatically documented by using the technique described above, because it is impossible to evaluate the individual opinions of the users, it is difficult to increase the number of input opinions by enhancing the users' motivations, and the discussions thus become stagnant.

### SUMMARY

According to an aspect of an embodiment, a non-transitory computer-readable recording medium stores therein a program that causes a computer to execute a process. The process includes selecting nodes from among a plurality of nodes included in a tree diagram that is generated according to nodes each representing an opinion created by each user to derive a solution to a problem dealt with in a discussion and links each representing relevance between the nodes, by tracking links backward from a solution node representing the solution to an assignment node representing an assignment, the selected nodes being included between the solution node and the assignment node; calculating a degree of contribution made by each of the selected nodes in deriving the solution, by using types of the selected nodes and types of the links; and identifying one or more of the nodes of which the degree of contribution is equal to or higher than a threshold value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration of a system according to a first embodiment;

FIG. 2 is a diagram for explaining an example in which the system according to the first embodiment is utilized;

FIG. 3 is a diagram for explaining an example of a functional configuration of a creativity aiding server;

FIG. 4 is a table illustrating examples of information stored in a node link information database (DB);

FIG. 5 is a diagram illustrating examples of information stored in a tree diagram DB;

FIG. 6 is a table illustrating examples of information stored in a contribution degree DB;

FIG. 7 is a table illustrating examples of information stored in a turning point DB;

FIG. 8 is a drawing for explaining details of a proposal node;

FIG. 9 is a drawing for explaining details of an evaluation node;

FIG. 10 is a diagram for explaining an example of calculating a degree of contribution made by a proposal;

FIG. 11 is a diagram for explaining an example of calculating a degree of contribution from evaluations;

FIG. 12 is a diagram for explaining a mechanism of evaluations;

FIG. 13 is a table illustrating a total score of each of the nodes;

FIG. 14 is a drawing for explaining an example of an enlarged display;

FIG. 15 is a drawing for explaining an example of a collapsed display;

FIG. 16 is a drawing for explaining an example of a hierarchical display using a time axis;

FIG. 17 is a flowchart illustrating a flow in a process; and

FIG. 18 is a diagram for explaining an example of a hardware configuration.

### DESCRIPTION OF EMBODIMENTS

Preferred embodiments will be explained with reference to accompanying drawings. The present disclosure is not limited by the exemplary embodiments.

### [a] First Embodiment

### An Overall Configuration

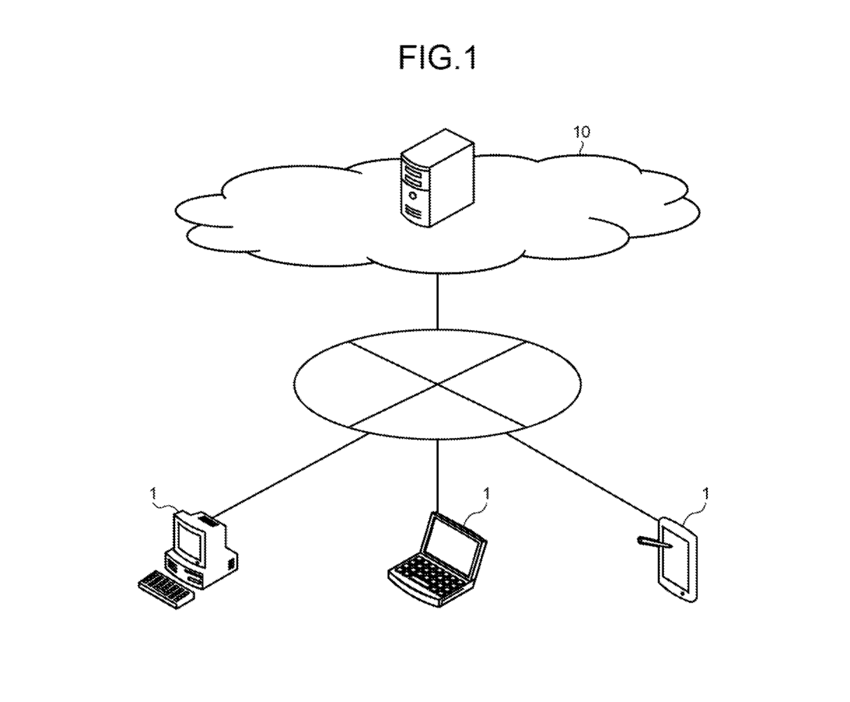

FIG. 1 is a diagram illustrating an example of an overall configuration of a system according to a first embodiment. As illustrated in FIG. 1, the system is a creativity aiding system in which a plurality of users exchange opinions about various assignments so as to derive solutions. The system includes a plurality of user terminals 1 and a creativity aiding server 10.

In the first embodiment, an example will be explained in which the creativity aiding server 10 is present in a cloud system, while each of the user terminals 1 is configured to use the system by accessing the creativity aiding server 10 via a network such as the Internet; however, possible embodiments are not limited to this example. For instance, the plurality of user terminals 1 and the creativity aiding server 10 may be connected to each other via a Local Area Network (LAN). The mode in which the system is utilized may arbitrarily be changed.

Each of the user terminals 1 is a terminal used by a user and may be configured by using a personal computer, a mobile phone, a smartphone, or the like, for example. Each of the user terminals 1 is configured to access the creativity aiding server 10 and to have a discussion in a group so as to derive a solution. The creativity aiding server 10 is an example of the evaluation apparatus. The creativity aiding server 10 provides the group including two or more of the user terminals 1 with an opportunity to hold a discussion and visualizes the discussion by expressing the opinions and the like created by the users while using nodes.

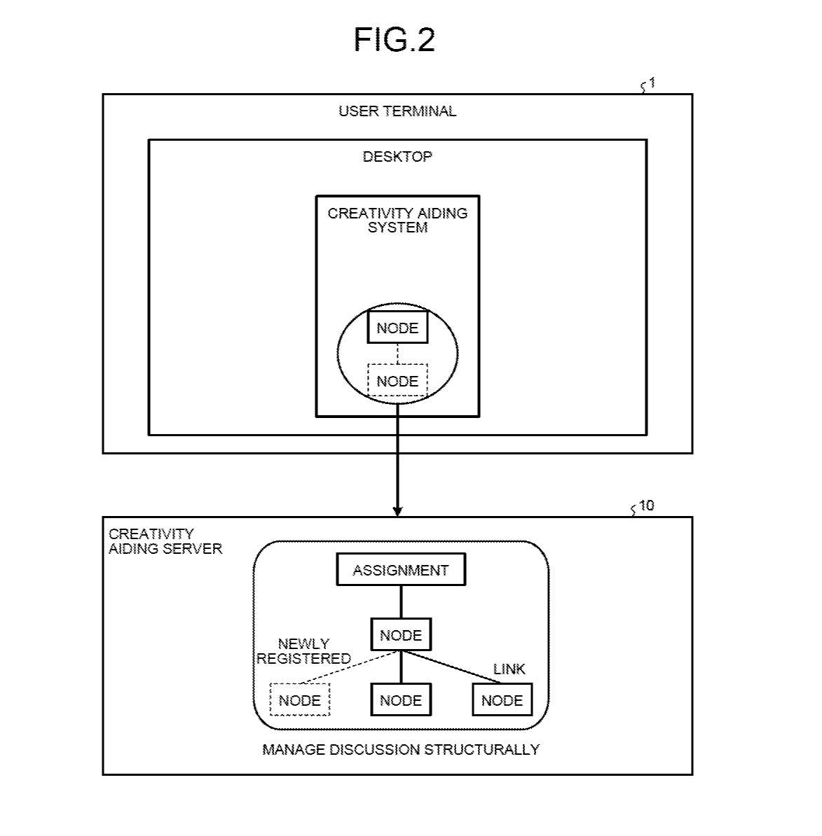

Next, the visualization of the discussion will be explained, with reference to FIG. 2. FIG. 2 is a diagram for explaining an example in which the system according to the first embodiment is utilized. As illustrated in FIG. 2, any one of the user terminals 1 logs into the creativity aiding system and displays an input screen for the creativity aiding system on the desktop thereof. In this situation, the user performs normal work duties while belonging to a project. The user performs various activities related to the work duties such as reading e-mails, replying to e-mails, and searching information on the web while performing the work duties.

During browsing on the web, when some information useful for an assignment of the group to which the user terminal 1 belongs is found, the user terminal 1 records the information therein so as to be kept in association with the assignment. For example, as illustrated in FIG. 2, the user terminal 1 records the information found during the web browsing in a “node” representing an opinion or a proposal. When recording the information, the user terminal 1 connects the information by using a “link”, so as to be kept in association with either the assignment or another piece of information previously recorded. Members participating in the project sequentially collect information and generate a tree diagram (a structure). In the following sections, nodes may be expressed in a simplified manner by using time stamps or user names. For example, a node having a time stamp 5 may be expressed as node 5, whereas a node generated by user A may be expressed as node A.

The creativity aiding server 10 brings a degree of contribution of each of the members to the surface and enhances motivations of the members, by judging which opinion from which member contributed to the solution for the assignment, in the tree diagram generated by using the nodes representing opinions from the members participating in the project, and the like.

A Functional Configuration

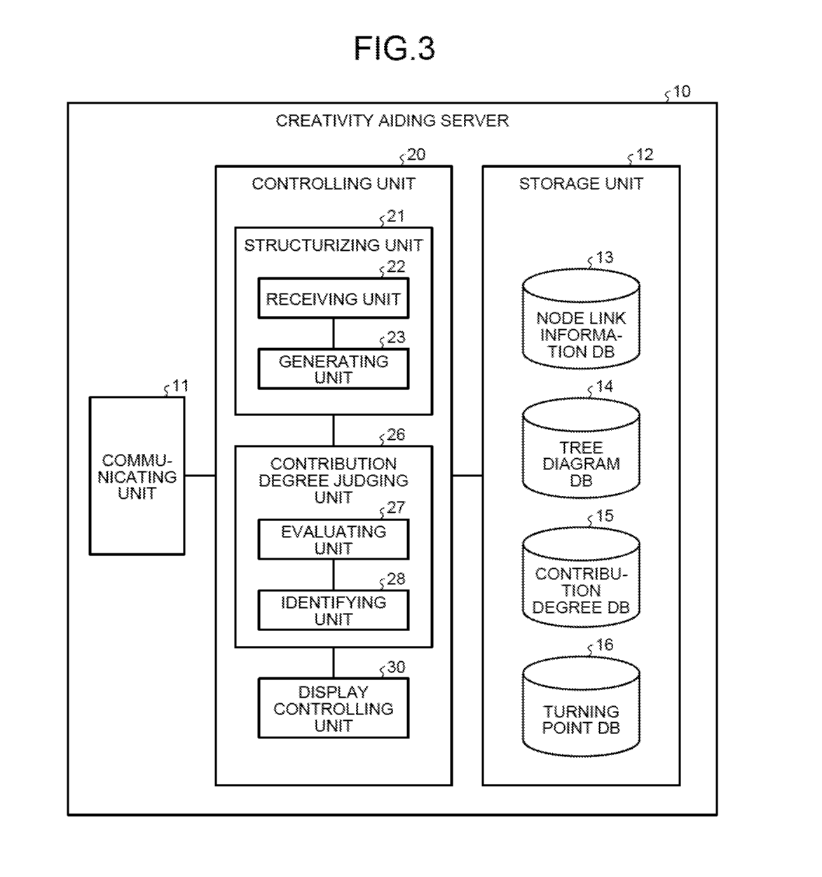

FIG. 3 is a diagram for explaining an example of a functional configuration of the creativity aiding server 10. As illustrated in FIG. 3, the creativity aiding server 10 includes a communicating unit 11, a storage unit 12, and a controlling unit 20.

The communicating unit 11 is a processing unit that controls communication with each of the user terminals 1, regardless of whether the communication is wired or wireless. For example, the communicating unit 11 receives an input of a node or a link (explained later) from any of the user terminals 1 and transmits various types of messages and the like aiding creativity to any of the user terminals 1.

The storage unit 12 is a storage device storing therein computer programs executed by the controlling unit 20 and data that is used when various types of preprocess are executed. The storage unit 12 may be configured by using a hard disk or a memory, for example. The storage unit 12 includes a node link information database (DB) 13, a tree diagram DB 14, a contribution degree DB 15, and a turning point DB 16.

The node link information DB 13 is a database storing therein information related to the nodes and the links structuring the tree diagram. More specifically, the node link information DB 13 stores therein a score indicating a degree of contribution of each user who input one or more nodes and/or links and the like, so as to be kept in correspondence with nodes and links that can be input to the tree diagram.

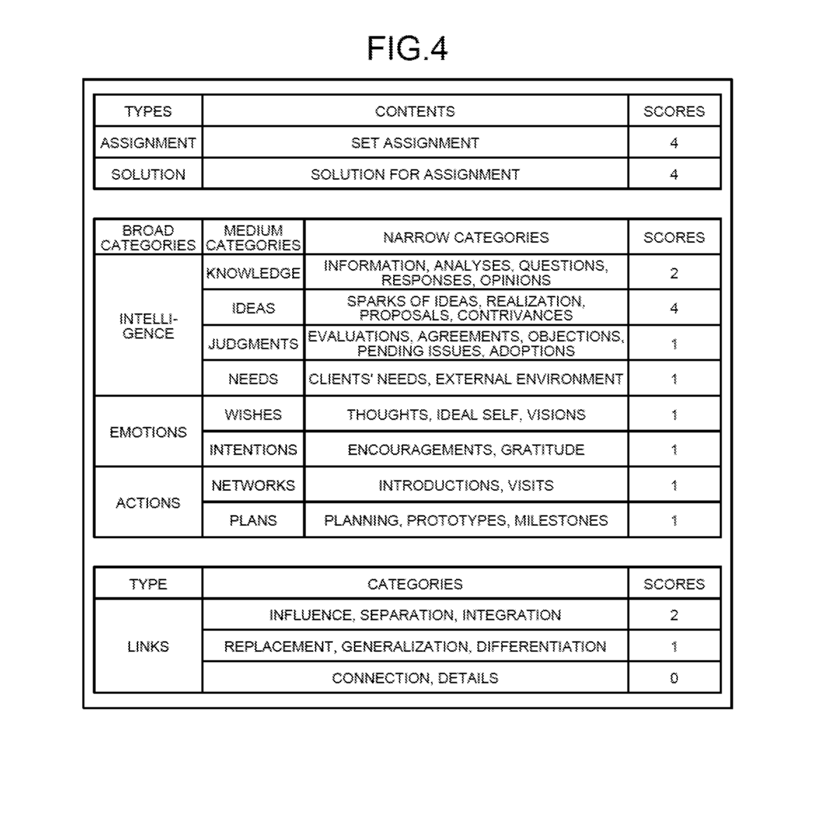

FIG. 4 is a table illustrating examples of the information stored in the node link information DB 13. As illustrated in FIG. 4, the node link information DB 13 stores therein “types, contents, and scores” that are kept in correspondence with one another. In the stored information, the “types” each indicates the type of a node created and generated by a user. The “contents” indicate the contents of a creation or an idea identified by the node. The “scores” each indicate a degree of contribution of a user who created and generated the node. The example illustrated in FIG. 4 indicates that a score “4 points” is given to a user who generated the node “assignment” to set the assignment for the discussion and that a score “4 points” is given to a user who generated the node “solution” for the assignment.

Further, as illustrated in FIG. 4, the node link information DB 13 stores therein “broad categories, medium categories, narrow categories, and scores” that are kept in correspondence with one another. In the stored information, the “broad categories, medium categories, and narrow categories” each indicate a category of nodes created and generated. The “scores” each indicate a degree of contribution of a user who created and generated the node. The example illustrated in FIG. 4 indicates that a score “4 points” is given to a user who generated the node corresponding to the narrow category “proposals” in the medium category “ideas” in the broad category “intelligence”. Further, the example illustrated in FIG. 4 indicates that a score “1 point” is given to a user who generated the node corresponding to the narrow category “evaluations” in the medium category “judgments” in the broad category “intelligence”.

Further, as illustrated in FIG. 4, the node link information DB 13 stores therein “type, categories, and scores” that are kept in correspondence with one another. In the stored information, the “type” indicates that the type represents links which keep nodes related to each other. The “categories” each indicate the contents of a link. The “scores” each indicate a degree of contribution of a user who generated the link. The example illustrated in FIG. 4 indicates that a score “2 points” is given to a user who connected nodes together by using a link “influence” and that a score “1 point” is given to a user who connected nodes together by using a link “differentiation”.

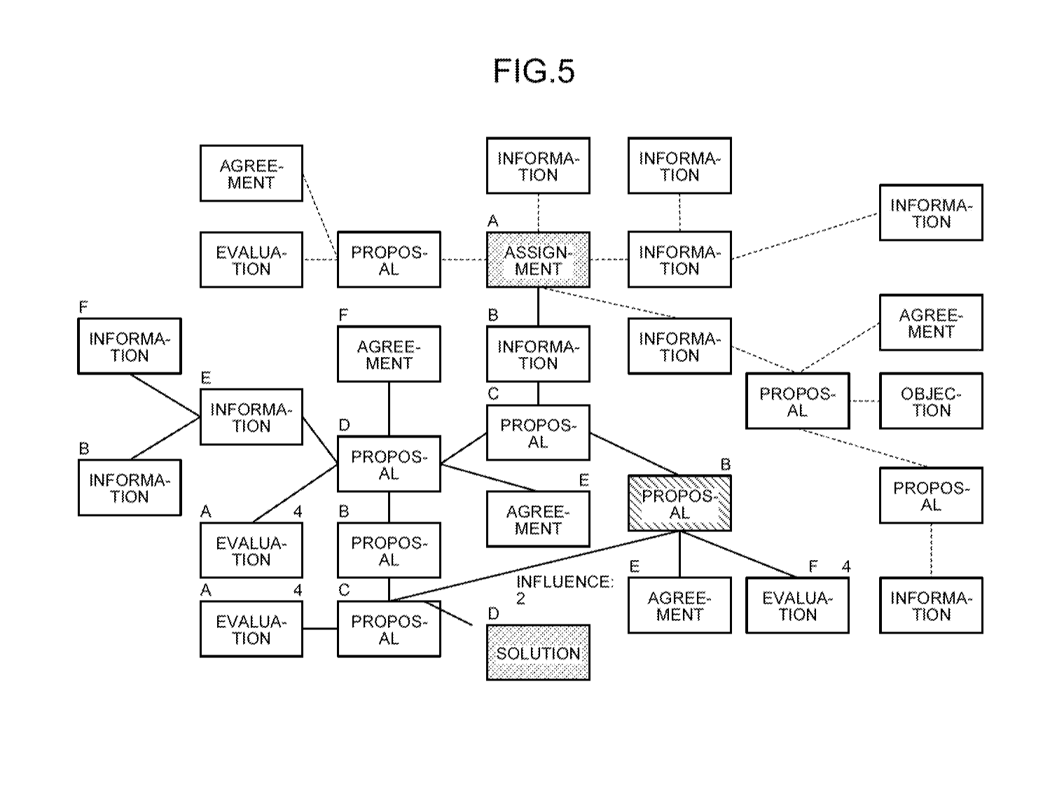

The tree diagram DB 14 is a database storing therein one or more tree diagrams generated by using nodes and links. More specifically, the tree diagram DB 14 stores therein the one or more tree diagrams each visualizing a discussion. FIG. 5 is a diagram illustrating examples of the information stored in the tree diagram DB 14. As illustrated in FIG. 5, the tree diagram DB 14 stores therein a result of a discussion about the node “assignment” generated by user A.

In the present example, the nodes “information” each represent a piece of information generated in relation to the assignment or other nodes and are categorized in the medium category “knowledge” in the broad category “intelligence”. The nodes “proposal” each represent the contents of what is proposed in relation to the assignment or other nodes and are categorized in the medium category “ideas” in the broad category “intelligence”. The nodes “agreement” each represent an agreement to a proposal, whereas the node “objection” represents an objection to a proposal, and the nodes “agreement” and “objection” are categorized in the medium category “judgments” in the broad category “intelligence”. Similarly, the nodes “evaluation” each represent an evaluation made on a proposal and are categorized in the medium category “judgments” in the broad category “intelligence”. The node “solution” represents a solution for the assignment.

The link “influence” indicates that the node is influenced by another node. The example illustrated in FIG. 5 indicates that the node “proposal” generated by user C was influenced by the node “proposal” generated by user B and that two points are added to the node “proposal” generated by user B.

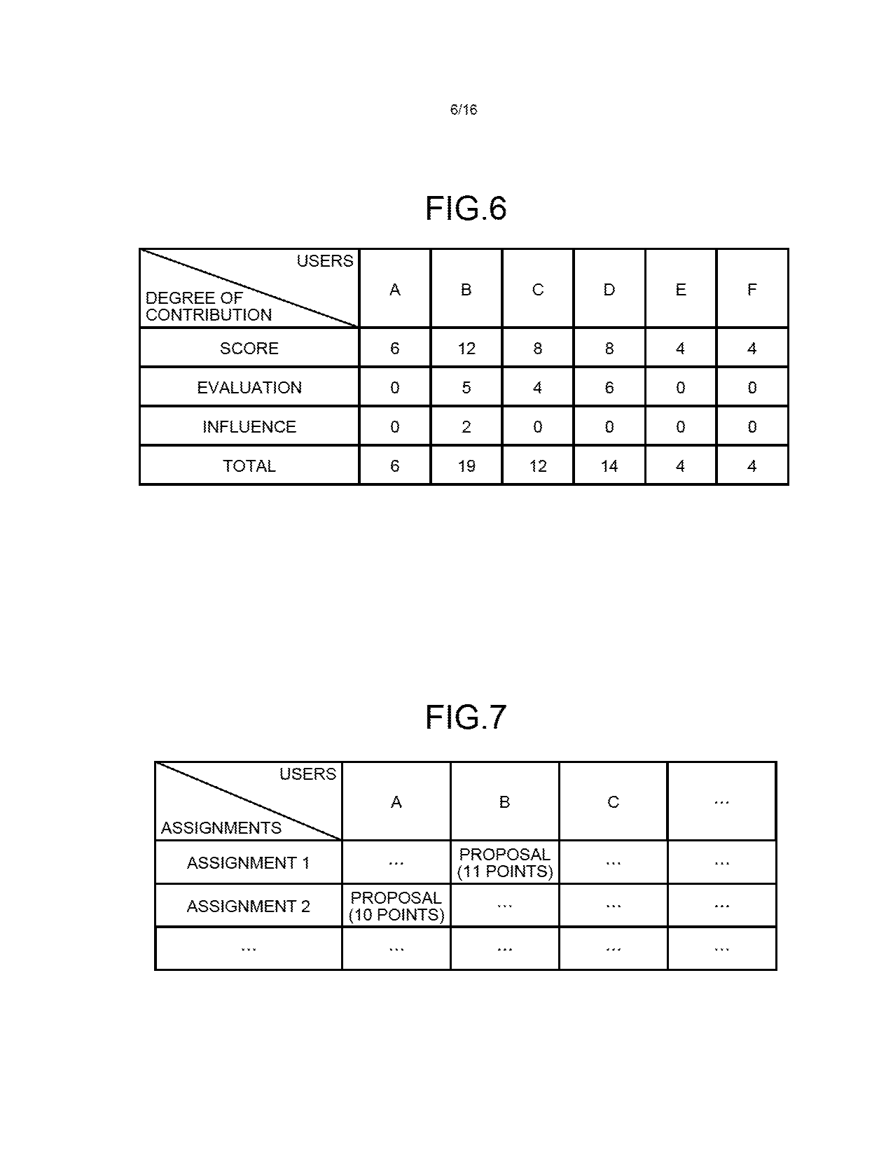

The contribution degree DB 15 is a database recording therein degrees of contribution of the users for each discussion. More specifically, for each of the discussions about various assignments, the contribution degree DB 15 stores therein a total score during the discussion calculated as a sum of: a score given to each of the users, a score earned by each of the users through an evaluation, and a score earned by each of the users by influencing one or more other users. FIG. 6 is a table illustrating examples of the information stored in the contribution degree DB 15. The example illustrated in FIG. 6 indicates the degrees of contributions of the users in the tree diagram illustrated in FIG. 5.

As illustrated in FIG. 6, the contribution degree DB 15 stores therein “a score, an evaluation (score), an influence (score), and a total” for each of the users. In the present example, the “score” denotes a total of the points earned from the one or more nodes generated by the user. The “evaluation” denotes a total of the points earned through evaluations made by other users on the one or more nodes generated by the user. The “influence” denotes a total of the points earned as a result of the one or more nodes generated by the user influencing other users. The “total” denotes a total of the “score, evaluation (score), and influence (score)”. The example illustrated in FIG. 6 indicates that the points earned by the user amounts to a total of “19 points”, which is a sum of “score=12, evaluation=5, and influence=2”.

The turning point DB 16 is a database storing therein “turning points” each indicating a node that had an influence toward the solution for the assignment. In other words, by referring to the information stored in the turning point DB 16, it is possible to identify which user provided useful information about which assignment.

FIG. 7 is a table illustrating examples of the information stored in the turning point DB 16. As illustrated in FIG. 7, the turning point DB 16 stores therein “users and assignments” that are kept in correspondence with one another. In the stored information, the “users” indicate pieces of information each identifying a user and may be represented by, for example, user names or user IDs. The “assignments” indicate assignments for each of which a discussion was held. The example illustrated in FIG. 7 indicates that, for assignment 1, the node “proposal” generated by user B served as a turning point and that “11 points” were given to the node.

The controlling unit 20 is a processing unit that controls the entirety of the creativity aiding server 10 and may be configured by using a processor, for example. The controlling unit 20 includes a structurizing unit 21, a contribution degree judging unit 26, and a display controlling unit 30. In this situation, the structurizing unit 21, the contribution degree judging unit 26, and the display controlling unit 30 may be examples of electronic circuits included in the processor or may be examples of processes executed by the processor.

The structurizing unit 21 is a processing unit that receives the generating of a node or a link and structurizes a discussion. In other words, the structurizing unit 21 visualizes the discussion by generating the tree diagram. The structurizing unit 21 includes a receiving unit 22 and a generating unit 23. The structurizing unit 21 performs a generally-used log-in process on each of the users and executes the processes hereinafter on each of the users who were logged-in.

The receiving unit 22 is a processing unit that receives one or more nodes and/or links from any of the user terminals 1. For example, the receiving unit 22 causes the user terminal 1 of a user who was logged in, to display a top screen for a creativity aiding system screen. Further, the receiving unit 22 receives an instruction to generate any of the various types of nodes such as “assignment”, “proposal”, and “agreement” or an instruction to generate a link, on the creativity aiding system screen corresponding to an assignment selected from among a plurality of assignments. After that, when having received the generation instruction, the receiving unit 22 requests the generating unit 23 to perform the process of generating the node or the link.

The generating unit 23 is a processing unit that generates the node or the link according to the generation instruction to generate the node or the link received by the receiving unit 22 and further generates a tree diagram by executing the process of structurizing the discussion. More specifically, the generating unit 23 causes the creativity aiding system screen displayed on a user terminal 1 to display the “types”, the “broad categories”, and the like stored in the node link information DB 13 illustrated in FIG. 4 and further receives information about a node to be generated, from the user. After that, the generating unit 23 generates the “node” corresponding to the received information.

In addition, when having generated the “node”, the generating unit 23 causes the “type” of the link and the like stored in the node link information DB 13 illustrated in FIG. 4 to be displayed. When having received a selection from the user, the generating unit 23 sets the received link between the nodes. Further, when having received no selection from the user, the generating unit 23 does not set any link between the nodes. Further, a time stamp is appended to each of the nodes to indicate the date and time at which the node was generated. Because the time stamp is appended to each of the nodes, it is possible to uniquely manage each of the individual nodes. For example, it is possible to manage the nodes by appending node numbers thereto according to the order in which the nodes were registered.

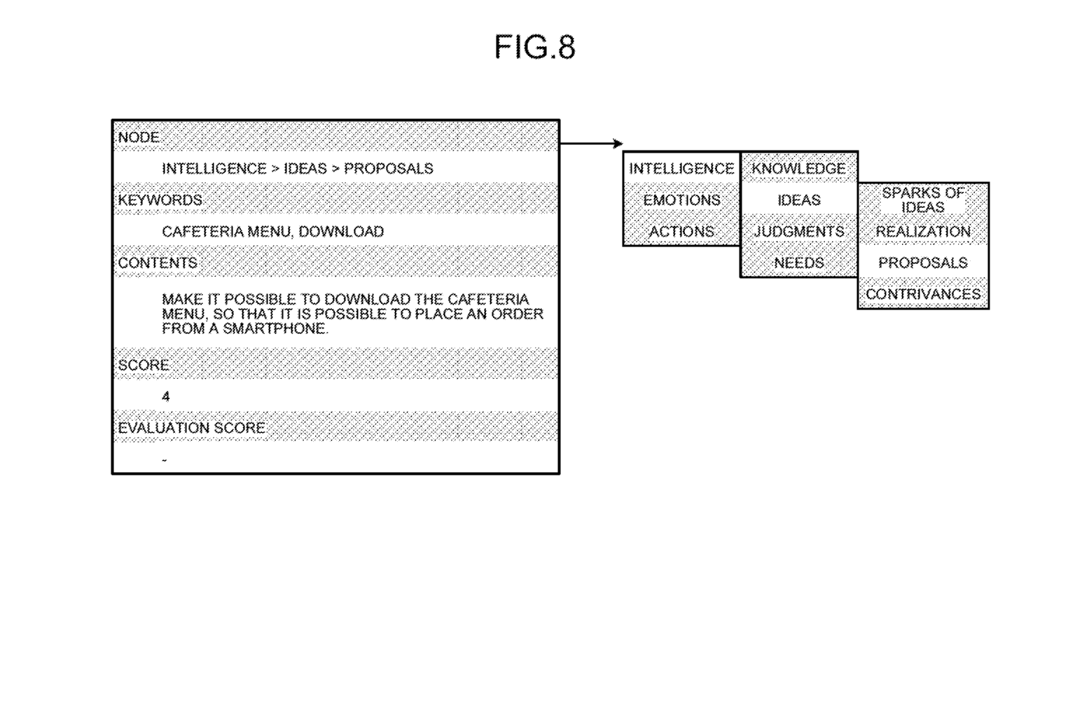

Next, the process of generating the nodes will be explained. FIG. 8 is a drawing for explaining details of a proposal node. The proposal node illustrated in FIG. 8 is a node corresponding to the node “proposal”. As illustrated in FIG. 8, the generating unit 23 causes the broad categories “intelligence, emotions, and actions” to be displayed and further receives a selection of a node to be generated, from one of the pull-down menus corresponding to the categories. The example illustrated in FIG. 8 indicates a situation in which the narrow category “proposal” in the medium category “ideas” in the broad category “intelligence” has been selected.

Subsequently, the generating unit 23 receives an input of “cafeteria menu, download” as keywords corresponding to this node and further receives the contents of a new proposal such as “Make it possible to download the cafeteria menu, so that it is possible to place an order from a smartphone”. Further, the generating unit 23 identifies the score “4 points” corresponding to the narrow category “proposal” of the node from the node link information DB 13 illustrated in FIG. 4 and sets the score with the node. Thus, the generating unit 23 has received the input of the node “proposal” and generated the node.

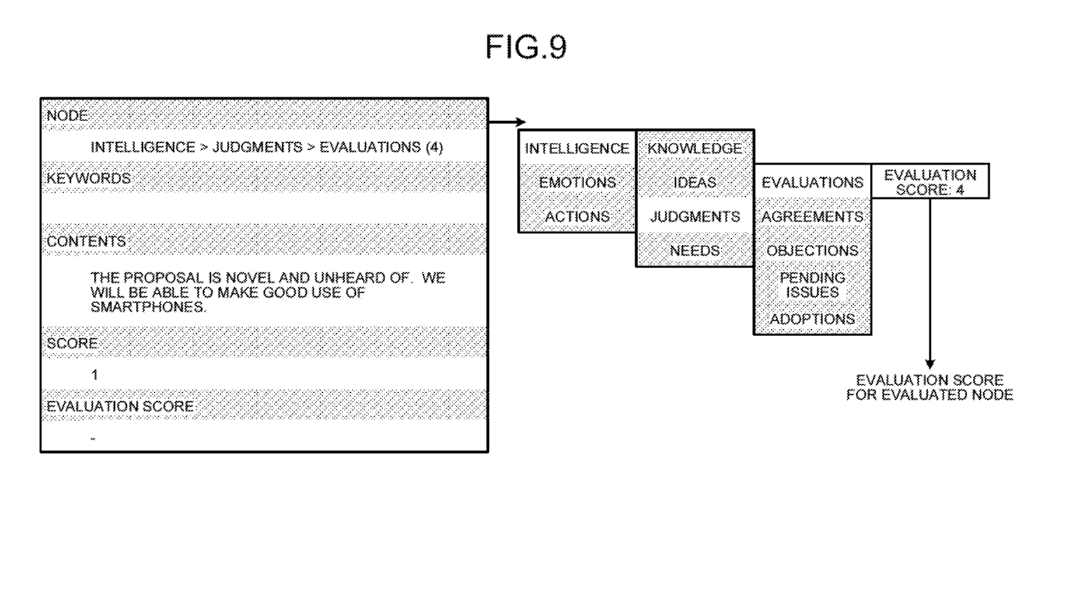

Next, the evaluation node will be explained. FIG. 9 is a drawing for explaining details of an evaluation node. The evaluation node illustrated in FIG. 9 is a node corresponding to the node “evaluation”. As illustrated in FIG. 9, the generating unit 23 causes the broad categories “intelligence, emotions, and actions” to be displayed and further receives a selection of a node to be generated, from one of the pull-down menus corresponding to the categories. The example illustrated in FIG. 9 indicates a situation in which “4 points” corresponding to the narrow category “evaluation” in the medium category “judgments” in the broad category “intelligence” has been selected. The evaluation score illustrated in FIGS. 8 and 9 is an evaluation score given to this node by other people.

Subsequently, the generating unit 23 receives the contents of an evaluation that is to be set with this node and reads “The proposal is novel and unheard of. We will be able to make good use of smartphones”. Further, the generating unit 23 identifies the score “1 point” corresponding to the narrow category “evaluation” of the node, from the node link information DB 13 illustrated in FIG. 4, and further sets the score with the node. Thus, the generating unit 23 has received the input of the node “evaluation” and generated the node.

Next, the process of generating a link will be explained, with reference to FIG. 5. Let us assume that, according to an instruction from user C, the generating unit 23 has generated a node “proposal” in relation to the node “proposal” generated by user B. In that situation, the generating unit 23 causes a menu or the like used for having the “type” of the “link” selected to be displayed near the generated node “proposal”. After that, when the “influence” of the “type” is selected, the generating unit 23 gives the score “2 points” corresponding to the type “influence” to the node “proposal” generated by user B. In this manner, the generating unit 23 has received the input of the “link” to be placed between the nodes and generated the link.

The contribution degree judging unit 26 includes an evaluating unit 27 and an identifying unit 28 and is a processing unit that, by employing these units, calculates a degree of contribution of each of the users, with respect to a discussion in which a solution for an assignment is generated.

The evaluating unit 27 is a processing unit that evaluates a degree of contribution of each of the users by calculating a sum of the “scores” earned from the categories of the nodes and the like and the “evaluation scores” earned from the links and the like, with respect to the nodes from the node “assignment” to the node “solution”. Further, the evaluating unit 27 stores the degree of contribution of each of the users into the contribution degree DB 15 and instructs the identifying unit 28 to start a process. In this situation, the evaluation scores may be configured so that selectable point values are kept in correspondence in advance with each of the nodes or may be configured so that the user sets an arbitrary point value.

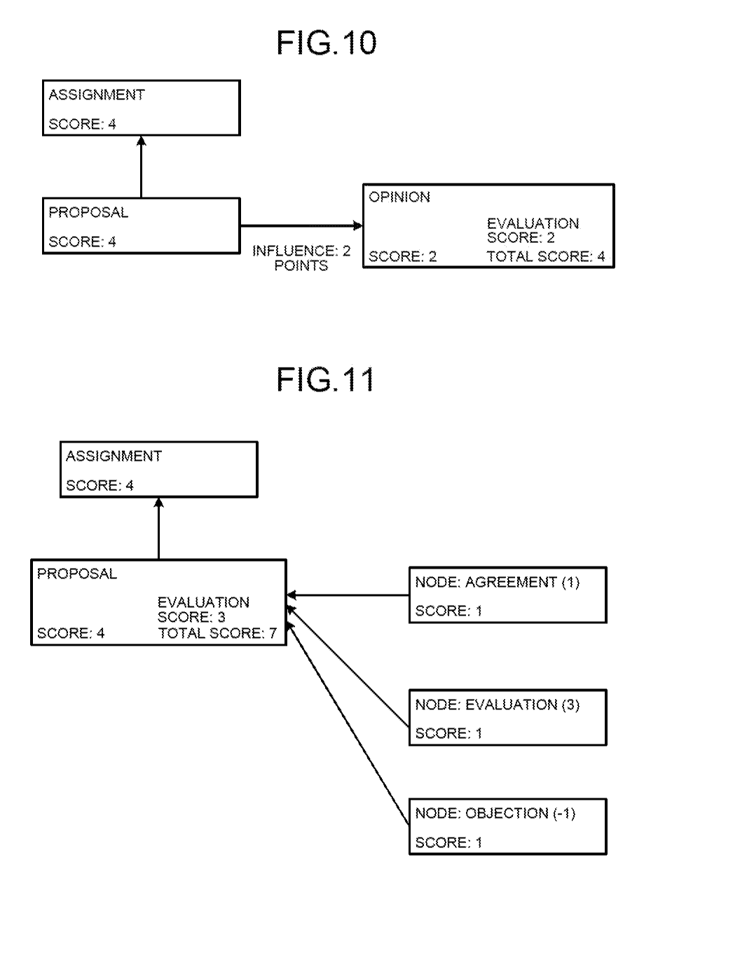

Next, an example of an evaluation method will be explained. FIG. 10 is a diagram for explaining an example of calculating a degree of contribution made by a proposal. As illustrated in FIG. 10, the evaluating unit 27 calculates a score “4 points” as the degree of contribution of the node “assignment”, by referring to the information stored in the node link information DB 13 illustrated in FIG. 4 and also calculates a score “4 points” for the node “proposal”. Further, the evaluating unit 27 calculates a score “2 points” for the node “opinion”, by referring to the information stored in the node link information DB 13 illustrated in FIG. 4 and further adds an evaluation score “2 points” thereto because a link “influence” is set therewith. Thus, the evaluating unit 27 calculates “4 points” as a total score. In other words, when the node “proposal” is presented, the evaluating unit 27 also evaluates the opinion that is original, if the node is presented while the previously-presented opinion is taken into account.

Next, an example of the process of calculating a degree of contribution when an evaluation is made on another node will be explained. FIG. 11 is a diagram for explaining an example of calculating a degree of contribution from evaluations. As illustrated in FIG. 11, the evaluating unit 27 calculates a score “4 points” as the degree of contribution of the node “assignment” and further calculates a score “4 points” for the node “proposal”, by referring to the information stored in the node link information DB 13 illustrated in FIG. 4. Further, the evaluating unit 27 calculates a score “1 point” for the node “agreement”, the node “evaluation”, and the node “objection”, which are evaluation nodes for the node “proposal”. In this situation, the evaluating unit 27 detects that, to the node “proposal”, the node “agreement” gave an evaluation score “1 point”, the node “evaluation” gave an evaluation score “3 points”, and the node “objection” gave an evaluation score “−1 point”. As a result, the evaluating unit 27 calculates a total score of “7 points” for the node “proposal”, by adding the evaluation scores “1 point, 3 points, and −1 point” to the “4 points” at the beginning. In other words, the evaluating unit 27 calculates the total score not only from the score earned by the node itself, but also by adding the evaluation scores from the other people thereto.

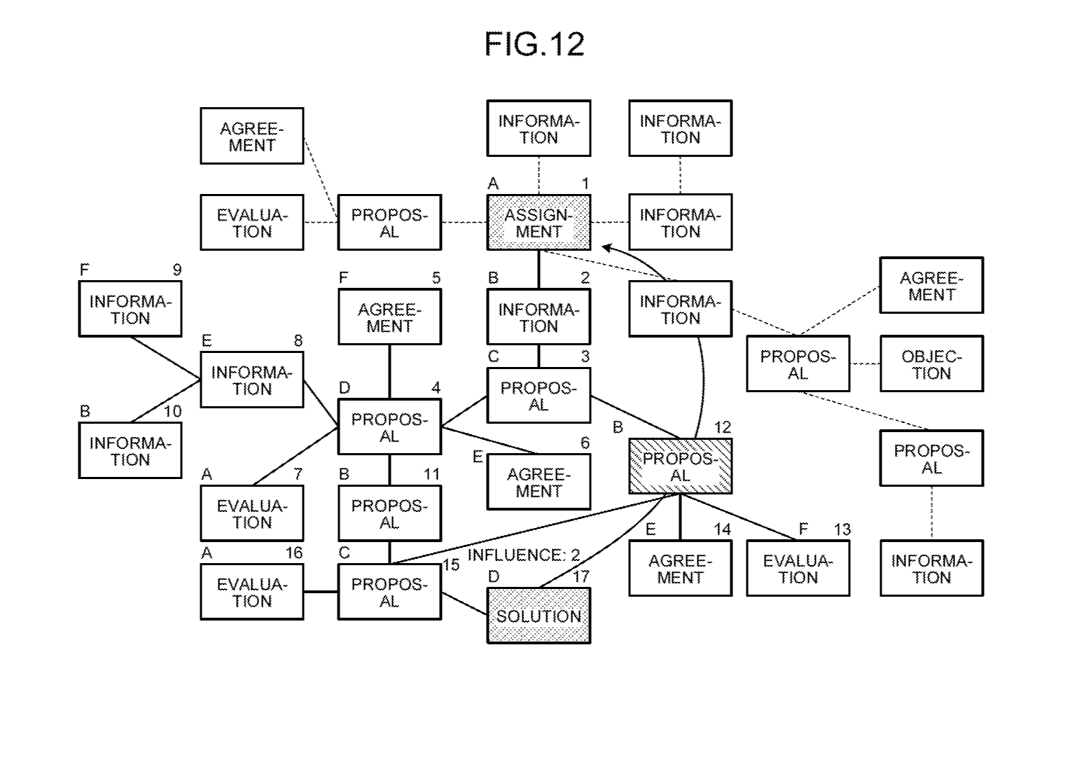

Next, a mechanism of evaluations that are made on the tree diagram visualizing the discussion by using the evaluation method described above will be explained more specifically. FIG. 12 is a diagram for explaining the mechanism of the evaluations. As illustrated in FIG. 12, when user D has derived the node “solution” with respect to the node “assignment” generated by user A, the evaluating unit 27 tracks the record of information from the past and a history of proposals before arriving at the solution and evaluates a degree of contribution of each of the elements toward the solution for the assignment.

More specifically, at first, the evaluating unit 27 tracks the nodes backward from the node “solution” to the node “assignment” and selects the nodes that are present in the positions from the node “solution” to the node “assignment”, as the nodes to be evaluated. Subsequently, by referring to the time stamp appended to each of the nodes, the evaluating unit 27 identifies the order in which the nodes were generated (posted). FIG. 12 indicates that the nodes were generated in the order indicated by the numbers appended to the nodes.

Subsequently, the evaluating unit 27 calculates a total score of the points for each of the nodes by taking into account the score earned by the node itself, the evaluation scores, the scores earned by the links, and the like, in the chronological order of the time stamps starting with the earliest time stamp. For example, with respect to the node “assignment” having the time stamp 1, the evaluating unit 27 calculates a total score “4 points”, which was earned by the node itself. Further, with respect to the node “information” having the time stamp 2, the evaluating unit 27 calculates a total score “2 points”, which was earned by the node itself.

Further, with respect to the node “proposal” having the time stamp 4, the evaluating unit 27 calculates a total score “10 points” by adding, to the score “4 points” earned by the node itself, an evaluation score “1 point” from the node “agreement” having the time stamp 5, another evaluation score “1 point” from the node “agreement” having the time stamp 6, and yet another evaluation score “4 points” from the node “evaluation” having the time stamp 7.

Further, with respect to the node “proposal” having the time stamp 12, the evaluating unit 27 calculates a total score “11 points” by adding, to the score “4 points” earned by the node itself, an evaluation score “4 points” from the node “evaluation” having the time stamp 13, another evaluation score “1 point” from the node “agreement” having the time stamp 14, and yet another evaluation score “2 points” from the link “influence” connected thereto from the node “proposal” having the time stamp 15.

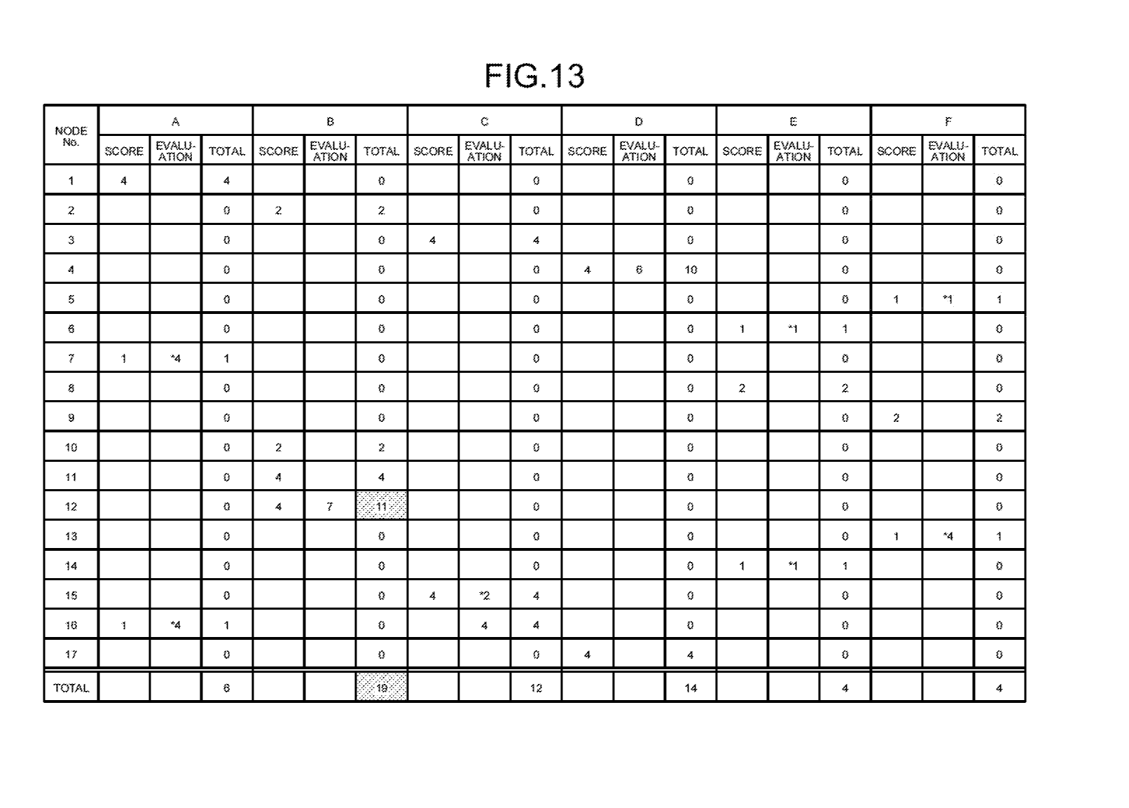

In the manner described above, the evaluating unit 27 calculates a total score for each of the nodes having the time stamps 1 to 17 appended thereto in FIG. 12. The results of the calculations of the total scores from FIG. 12 are illustrated in FIG. 13. FIG. 13 is a table illustrating the total score of each of the nodes. FIG. 13 illustrates a degree of contribution of each of the users in the tree diagram illustrated in FIG. 12. Further, the node numbers in FIG. 13 correspond to the order of the time stamps explained with reference to FIG. 12. In other words, in FIG. 13, the node “assignment” having the time stamp 1 is identified as node number 1 (hereinafter, “No. 1” and so on).

For example, with respect to user A, a total score from nodes No. 1, No. 7, and No. 16 generated by user A is calculated as the degree of contribution. More specifically, with respect to user A, a total score “4 points” is calculated for node No. 1, a total score “1 point” is calculated for node No. 7, and a total score “1 point” is calculated for node No. 16, and the degree of contribution is therefore calculated as “4+1+1=6 points”. The scores marked with the symbol “*” for nodes No. 7 and No. 16 each indicate an evaluation score given to another node. In other words, from node No. 7, it is indicated that user A gave an evaluation score “4 points” to another node, namely node No. 4.

Further, with respect to user B, a total score “2 points” is calculated for node No. 2, a total score “2 points” is calculated for node No. 10, a total score “4 points” is calculated for node No. 11, and a total score “11 points” is calculated for node No. 12, and the degree of contribution is therefore calculated as “2+2+4+11=19 points”.

Further, with respect to user C, a total score “4 points” is calculated for node No. 3, a total score “4 points” is calculated for node No. 15, and a total score “4 points” is calculated for node No. 16, and the degree of contribution is therefore calculated as “4+4+4=12 points”. By using the method described above, the degree of contribution of user D is calculated as “14 points”, while the degree of contribution of user E is calculated as “4 points”, and the degree of contribution of user F is calculated as “4 points”. After that, by using the results illustrated in FIG. 13, the evaluating unit 27 calculates the score, the evaluation, the influence, and the total for each of the users and stores the calculated point values into the contribution degree DB 15.

Returning to the description of FIG. 3, the identifying unit 28 is a processing unit that identifies a turning point, which is represented by a node that contributed the most to a solution for an assignment. More specifically, the identifying unit 28 identifies the node having the highest total score among the total scores of the nodes generated by the evaluating unit 27, as the turning point. For instance, in the example illustrated in FIG. 13, the identifying unit 28 identifies node No. 12 generated by user B having the highest total score “11 points” as the turning point. After that, the identifying unit 28 stores the identified turning point into the turning point DB 16, so as to be kept in correspondence with the user and the assignment.

As explained above, when a focus is placed on the individual nodes, it is observed that node No. 12 generated by user B has the highest score in the tree diagram illustrated in FIG. 12. It is understood that node No. 12 is the node that served as a turning point and had an influence toward the solution for the assignment. Accordingly, the identifying unit 28 transmits a message to a user terminal B or the like of user B. Examples of the transmitted message include a message indicating that user B is excellent, a message indicating that the degree of contribution of user B is high and wishing further success in the future, and a message indicating that the degree of contribution of user B is high and deserves an employee performance evaluation.

Further, when a focus is placed on the individual users, the identifying unit 28 identifies user B having the highest total score of 19 points, as the user having the highest degree of contribution. After that, the identifying unit 28 transmits the abovementioned message to the user terminal B or the like of user B.

In the description above, the examples are explained in which the single turning point or the single user having the highest degree of contribution is selected; however, possible embodiments are not limited to these examples. For instance, it is also acceptable to identify a plurality of turning points or a plurality of users exceeding a threshold value. For example, in the example illustrated in FIG. 13, the identifying unit 28 may identify nodes No. 12 and No. 10 of which the total score is equal to or higher than a threshold value (10 points), as turning points. Also, the identifying unit 28 may identify users B, C, and D whose degrees of contribution are equal to or higher than the threshold value (10 points), as users having higher degrees of contribution.

Further, the identifying unit 28 may identify a user having the highest score for each of the items (namely, the score, the evaluation, and the influence), by referring to the contribution degree DB 15 illustrated in FIG. 6. For example, the identifying unit 28 transmits a message indicating that the user is evaluated for having provided a highly-evaluated opinion, to the user having the highest score for the evaluation. Further, the identifying unit 28 transmits a message indicating that the user is evaluated for having provided a highly influential opinion, to the user having the highest score for the influence.

Returning to the description of FIG. 3, the display controlling unit 30 is a processing unit that changes the display method of any of the tree diagrams stored in the tree diagram DB 14. More specifically, in response to an instruction operation performed by the user, the display controlling unit 30 causes a tree diagram to be displayed on a display device or the like of a user terminal operated by any of the users, after changing the display format applied to the tree diagram DB 14.

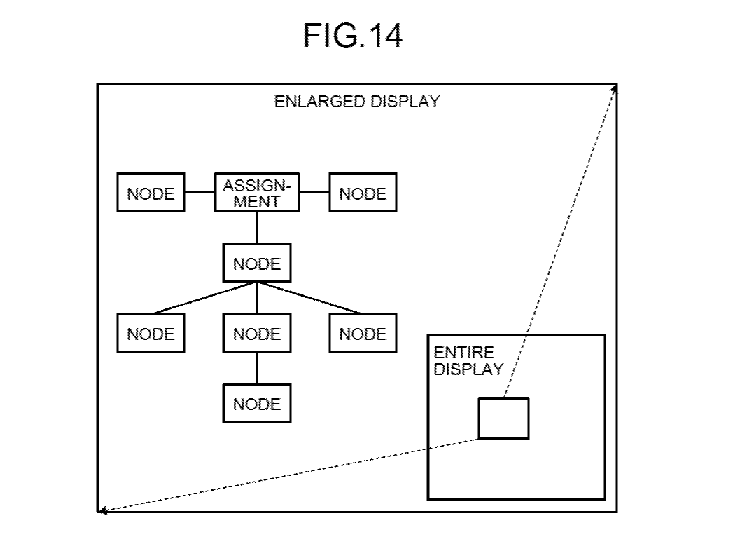

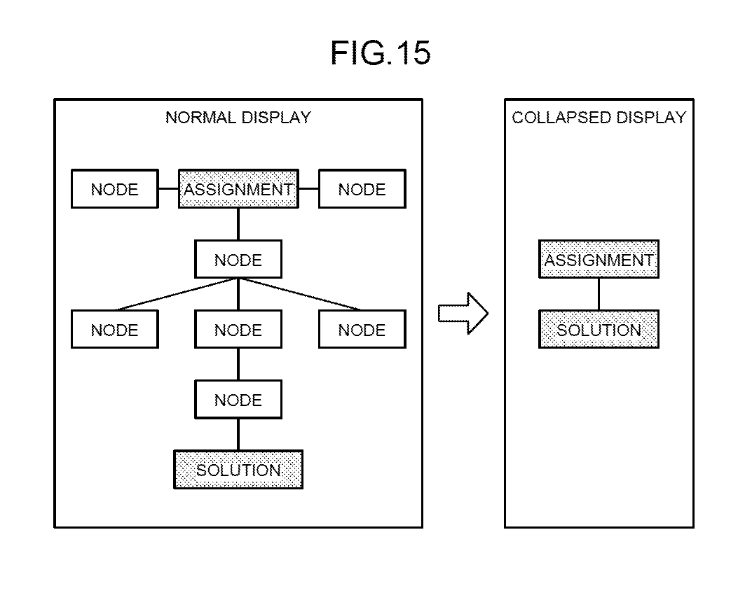

Next, specific examples of the display format will be explained. FIG. 14 is a drawing for explaining an example of an enlarged display. As illustrated in FIG. 14, when having received an operation to enlarge a part of a tree diagram generated by using nodes and links, the display controlling unit 30 displays the part indicated in the operation in an enlarged manner. FIG. 15 is a drawing for explaining an example of a collapsed display. As illustrated in FIG. 15, when having received an operation to collapse a tree diagram, the display controlling unit 30 displays the tree diagram in a collapsed manner that contains only the node “assignment” and the node “solution”. Examples of the enlarging operation and the collapsing operation include an operation performed on a menu displayed on a display device, an operation to designate an area by using a mouse or the like, and a double-click operation and a pinch-out operation performed on a touch panel.

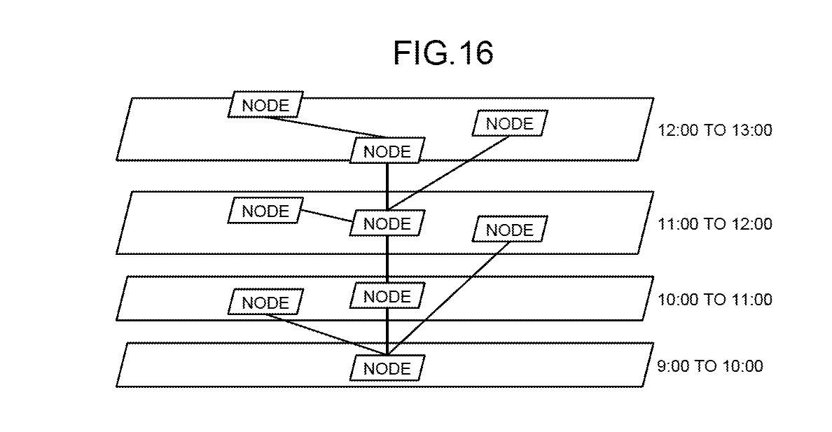

Further, the display controlling unit 30 is also capable of displaying the nodes structuring a tree diagram, in a hierarchical manner along a time axis, on the basis of the time stamps appended to the nodes. FIG. 16 is a drawing for explaining an example of the hierarchical display using a time axis. As illustrated in FIG. 16, the display controlling unit 30 divides the region into hierarchical levels representing the time period from 9:00 to 10:00, the time period from 10:00 to 11:00, the time period from 11:00 to 12:00, and the time period from 12:00 to 13:00. Further, the display controlling unit 30 displays one or more nodes corresponding to each of the hierarchical levels in a corresponding region. By using this configuration, the display controlling unit 30 is able to display, for the users, a time period during which a lively discussion is held, or the like.

A Flow in a Process

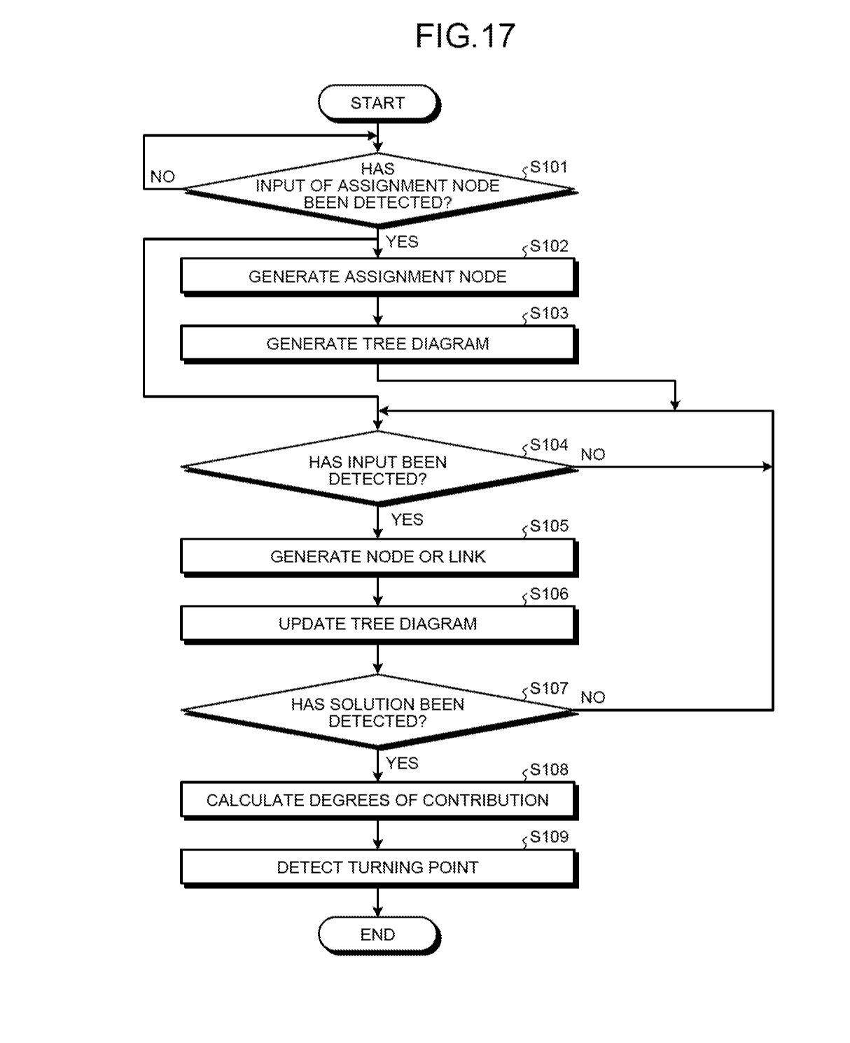

FIG. 17 is a flowchart for explaining a flow in a process. As illustrated in FIG. 17, when the receiving unit 22 has detected an input of a node of an assignment (step S101: Yes), the generating unit 23 generates a node “assignment” (step S102) and generates a tree diagram (step S103).

After that, when the receiving unit 22 has detected an input of a node or a link (step S104: Yes), the generating unit 23 generates the node or the link according to the contents of the detected input (step S105) and updates the tree diagrid (step S106).

After that, until a node “solution” is detected (step S107: No), the processes at and after step S104 are repeatedly performed. When a node “solution” is detected (step S107: Yes), the evaluating unit 27 identifies the nodes to be evaluated, calculates a total score of each of the identified nodes by taking the score, the evaluation score, and the influence thereof into consideration, and further calculates a degree of contribution of each of the users (step S108). In this situation, the evaluating unit 27 stores the total score of each of the nodes illustrated in FIG. 13 into the contribution degree DB 15 and stores the degree of contribution of each of the users into the contribution degree DB 15.

Subsequently, the identifying unit 28 identifies a node serving as a turning point, on the basis of the total scores of the nodes generated by the evaluating unit 27 (step S109). In this situation, the identifying unit 28 stores the identified turning point into the turning point DB 16.

### Advantageous Effects

As explained above, the creativity aiding server 10 is capable of identifying the node serving as the turning point that most influenced the solution for the assignment and is capable of evaluating the user who created the node. As a result, the creativity aiding server 10 is capable of promoting the enhancement of motivations of the users and to make the discussion lively. Further, by tracking the links, the creativity aiding server 10 is also capable of checking to see which opinions were influential. Further, the creativity aiding server 10 is capable of objectively evaluating the one or more persons who provided useful information.

By expressing the flow of the discussions by using the nodes and the links, the creativity aiding server 10 is capable of not only simply viewing the discussions in a time series, but also expressing the relevance in each of the discussions appropriately. Further, because the nodes have elements of innovation embedded therein, the creativity aiding server 10 makes clear which parts have insufficient discussions and therefore achieves an advantageous effect in making the discussions lively and helping the users to create ideas. When using the creativity aiding server 10, because the participants are able to hold individual discussions while grasping an overview of the discussions, the participants are able to easily return to a point where a discussion is interrupted.

By tracking the links, the creativity aiding server 10 is capable of checking to see which opinion influenced each of the nodes. Further, the creativity aiding server 10 is capable of calculating, as the degrees of contribution, which user was influenced in what manner, which user spoke how much, and which user made a contribution to the solution for the assignment. Further, by making the degrees of contribution of the users public, the creativity aiding server 10 is capable of promoting the enhancement of motivations of the users and to make the discussions lively.

The creativity aiding server 10 operates with the functions where a person praises another person, and at the same time, the system automatically gives a praise. As a result, it is possible to thank those people who provided information and to evaluate the degrees of contribution of those people. It is therefore possible to gratify the people who provided the information. Further, because the history up to the point when a conclusion is reached is recorded in the structurized graph, it is possible to detect effective information and ideas and to visualize the degrees of contribution to the project, by tracking backward from the conclusion. Consequently, the motivations of the individual participants are enhanced.

### [b] Second Embodiment

Some exemplary embodiments of the present disclosure have thus been explained; however, it is possible to carry out the present disclosure in various different modes other than those in the embodiments described above.

Calculations of the Degrees of Contribution

In the embodiment described above, the example is explained in which the creativity aiding server 10 calculates the degree of contribution of each of the nodes by using the score set with the node, the evaluation score designated to the node by another node, and the score from the influence or the like specified by the link; however, possible embodiments are not limited to this example. For instance, the creativity aiding server 10 may calculate a degree of contribution by using the score set with the node and the evaluation score or may calculate a degree of contribution by using the score set with the node and the score from the influence or the like, by arbitrarily combining any of the different types of scores. It is possible to judge whether a discussion is stagnant by referring to the time stamps. When a person presents a new proposal while a discussion is in a stagnant state, and if the proposal is a node leading to a solution, it is possible to evaluate such a proposal.

Tree Diagrams of Individual Participants

In the embodiment described above, the example of the group discussion is explained; however, possible embodiments are not limited to this example. It is possible to similarly process a discussion of an individual participant. Further, when discussions are held by different groups on mutually-the-same assignment, the creativity aiding server 10 is also capable of making the discussions lively by arranging tree diagrams from other groups to be displayed for each of the groups. Further, in the embodiment described above, the example of the tree diagram for deriving the solution from the assignment is explained; however, possible embodiments are not limited to this example. For instance, it is possible to similarly process a discussion in which participants exchange opinions on a theme. In that situation, the abovementioned assignment corresponds to the theme, while opinions correspond to the nodes, and a conclusion or the like corresponds to the solution. Further, although the proposals and the pieces of information are described as examples of the nodes, possible embodiments are not limited to these examples. It is possible to modify the configuration of the nodes, as appropriate, in accordance with the theme or the like. It is also possible to apply a modification to the evaluation scores and the like, as appropriate.

The Number of Assignments and Solutions

In the embodiment described above, the example is explained in which one solution is derived for one assignment; however, possible embodiments are not limited to this example. For instance, the creativity aiding server 10 is able to similarly process the situation in which a plurality of new assignments are proposed in a discussion about one assignment. For example, the creativity aiding server 10 is capable of calculating a total score of each of the nodes and a turning point and calculating a degree of contribution of each of the users, by tracking the nodes backward from a solution to the assignment, for each of the assignments. Also, the creativity aiding server 10 is capable of calculating a total score of each of the nodes and a turning point and calculating a degree of contribution of each of the users, with respect to the first assignment.

A Comprehensive Management of Input Information

Further, the creativity aiding server 10 is capable of storing, into the storage unit 12, all the nodes generated by each of the users and the times at which each of the users generated a node, so as to comprehensively manage these types of information for each of the users. By comprehensively managing the information in this manner, it is possible to count the number of nodes generated by each of the users in a long-term span such as one year and to evaluate the number of times each of the users spoke, and the like. Further, it is also possible to display the nodes in various colors, to make it possible to distinguish a node on which information, opinions, and the like are concentrated and a node having a high evaluation score.

Hardware

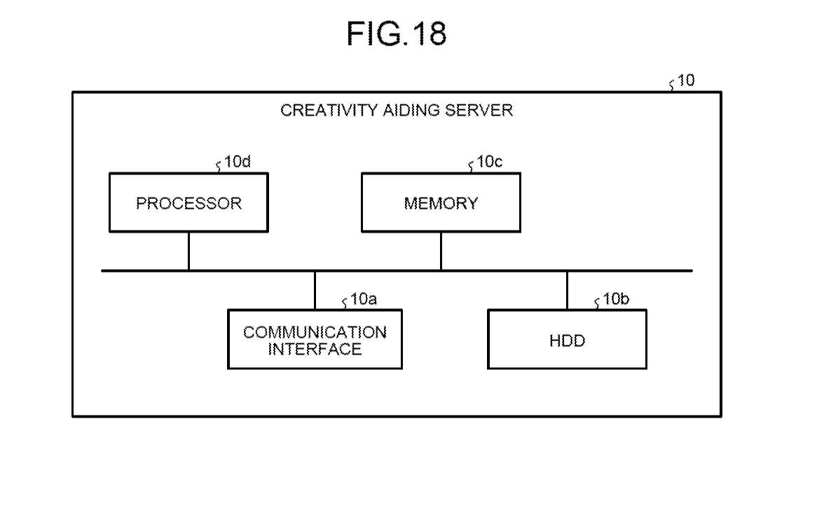

For example, the creativity aiding server 10 described above may be realized by using a computer having a hardware configuration as described below. FIG. 18 is a diagram illustrating an example of the hardware configuration. As illustrated in FIG. 18, the creativity aiding server 10 includes a communication interface 10a, a Hard Disk Drive (HDD) 10b, a memory 10c, and a processor 10d.

Examples of the communication interface 10a include a network interface card. The HDD 10b is a storage device that stores therein the various types of databases illustrated in FIG. 3.

Examples of the processor 10d include a Central Processing Unit (CPU), a Digital Signal Processor (DSP), a Field Programmable Gate Array (FPGA), and a Programmable Logic Device (PLD). Further, examples of the memory 10c include Random Access Memories (RAMs) such as a Synchronous Dynamic Random Access Memory (SDRAM), a Read-Only Memory (ROM), and a flash memory.

Further, the creativity aiding server 10 operates as an information processing apparatus that implements an evaluation method by reading a computer program (hereinafter, “program”) and executing the read program. In other words, the creativity aiding server 10 executes the program that executes the same functions as those of the structurizing unit 21, the contribution degree judging unit 26, and the display controlling unit 30. As a result, the creativity aiding server 10 is capable of executing processes that execute the same functions as those of the structurizing unit 21, the contribution degree judging unit 26, and the display controlling unit 30. In this situation, the program mentioned in the present additional embodiment does not necessarily have to be executed by the creativity aiding server 10. For example, the present disclosure is similarly applicable to situations where another computer or a server executes the program or where another computer and a server execute the program in collaboration with each other.

The program may be distributed via a network such as the Internet. Alternatively, the program may be recorded on a computer-readable recording medium such as a hard disk, a flexible disk (FD), a Compact Disk Read-Only Memory (CD-ROM), a Magneto-Optical (MO) disk, or a Digital Versatile Disc (DVD), so as to be executed as being read by a computer from the recording medium.

System

The constituent elements of the apparatuses and devices illustrated in FIG. 3 do not always need to be configured physically as illustrated. In other words, it is acceptable to distribute or integrate any of the constituent elements in any arbitrary units. For example, it is acceptable to integrate the structurizing unit 21 and the contribution degree judging unit 26 together. Further, all or an arbitrary part of the processing functions realized by the apparatuses and devices may be realized by a CPU and a program analyzed and executed by the CPU or may be realized as hardware using wired logic.

With regard to the processes explained in the embodiments above, it is acceptable to manually perform all or a part of the processes described as being performed automatically. Conversely, by using a method that is publicly known, it is also acceptable to automatically perform all or a part of the processes described as being performed manually. Further, unless noted otherwise, it is acceptable to arbitrarily modify any of the processing procedures, the controlling procedures, the specific names, and the information including the various types of data and parameters that are presented in the above text and the drawings.

According to at least one aspect of the embodiments disclosed herein, it is possible to make the discussions lively.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
selecting nodes from among a plurality of nodes included in a tree diagram that is generated according to nodes each representing an opinion created by each user to derive a solution to a problem dealt with in a discussion and links each representing relevance between the nodes, by tracking links backward from a solution node representing the solution to an assignment node representing an assignment, the selected nodes being included between the solution node and the assignment node;
calculating a degree of contribution made by each of the selected nodes in deriving the solution, by using types of the selected nodes and types of the links; and
identifying one or more of the nodes of which the degree of contribution is equal to or higher than a threshold value.

2. The non-transitory computer-readable recording medium according to claim 1, wherein the calculating includes calculating a total score as the degree of contribution for each of the selected nodes, using score that is set in advance for the type of each of the nodes, an evaluation score earned as a result of each of the nodes being evaluated by another node, and a score that is set in advance with the type of each of one or more links by which each of the nodes is connected.

3. The non-transitory computer-readable recording medium according to claim 1, wherein the process further includes transmitting a message indicating that the degree of contribution made to the solution is high, to a corresponding user who generates any of the nodes of which the degree of contribution is equal to or higher than the threshold value or a user terminal used by the corresponding user.

4. The non-transitory computer-readable recording medium according to claim 1, wherein the process further includes displaying a part of the tree diagram in an enlarged manner or in a collapsed manner, on a basis of an instruction operation performed by any of the users.

5. The non-transitory computer-readable recording medium according to claim 1, wherein the process further includes classifying the nodes included in the tree diagram according to a time period during which each of the nodes is generated and displaying the nodes by expressing the tree diagram on hierarchical levels along a time axis.

6. An evaluation method comprising:
selecting more nodes from among a plurality of nodes included in a tree diagram that is generated according to nodes each representing an opinion created by each user to derive a solution to a problem dealt with in a discussion and links each representing relevance between the nodes, by tracking links backward from a solution node representing the solution to an assignment node representing the assignment, the selected nodes being included between the solution node and the assignment node, using a processor;
calculating a degree of contribution made by each of the selected nodes in deriving the solution, by using types of the selected nodes and types of the links, using the processor; and
identifying one or more of the nodes of which the degree of contribution is equal to or higher than a threshold value, using the processor.

7. An evaluation apparatus comprising:
a memory; and
a processor that is connected to the memory, wherein the processor executes a process including:
selecting nodes from among a plurality of nodes included in a tree diagram that is generated according to nodes each representing an opinion created by each user to derive a solution to a problem dealt with in a discussion and links each representing relevance between the nodes, by tracking links backward from a solution node representing the solution to an assignment node representing the assignment, the selected nodes being included between the solution node and the assignment node;
calculating a degree of contribution made by each of the selected nodes in deriving the solution, by using types of the selected nodes and types of the links; and
identifying one or more of the nodes of which the degree of contribution is equal to or higher than a threshold value.
